(19) United States
(12) Patent Application Publication
(10) Pub. No.: US 2012/0198508 A1
(43) Pub. Date: Aug. 2, 2012

(54) MULTIPLE DEVICE IPTV CLOUD-BASED RECORDING AND PLAYBACK

(75) Inventor: Jenke Wu Kuo, San Diego, CA (US)

(73) Assignee: SONY CORPORATION, Tokyo (JP)

(21) Appl. No.: 13/018,566

(22) Filed: Feb. 1, 2011

(51) Int. Cl. H04N 7/173

(52) U.S. Cl. 725/110

(57) ABSTRACT

A cloud-based internet protocol television (IPTV) system is described here. In this invention, the cloud acts as a personal video recorder for recording and playback of audio, video, and other content. Communications to and from the cloud are transmitted over IPTV. An allowance for resolution and refresh rate conversion allows for high bandwidth content to be converted into lower bandwidth content. In this way, content stored from a high definition television may be converted to a content stream playable by a smart phone of limited capabilities. By using the cloud as storage, local devices may play only the IPTV streams, without the substantial storage capacities required for high definition video. IPTV-based menus are used to select media for recording and playback.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to recording and playback, and more particularly to recording and playback using a cloud-based architecture.

2. Description of Related Art

Internet Protocol television (IPTV) is a system through which Internet television services are delivered using the architecture and networking methods of the Internet Protocol Suite over a packet-switched network infrastructure, e.g., the Internet and broadband Internet access networks, instead of being delivered through traditional radio frequency broadcast, satellite signal, and cable television (CATV) formats.

IPTV services may be classified into three main groups: live television, with or without interactivity related to the current TV show; time-shifted programming: catch-up TV (replays a TV show that was broadcast hours or days ago), start-over TV (replays the current TV show from its beginning); and video on demand (VOD): browse a catalog of videos, not related to TV programming.

Cloud computing is Internet-based computing, whereby shared servers provide resources, software, and data to computers and other devices on demand, as with the electricity grid.

### BRIEF SUMMARY OF THE INVENTION

An aspect of the invention is a recording apparatus, which may comprise: a recording device; and means for storing a media stream received on the recording device to a cloud as a recording stream; wherein the recording stream is stored on the cloud as a stored medium in a collection of one or more stored media. The means for storing may comprise a recording computer program, executable by the recording device, for performing one or more steps comprising: accessing the media stream; and transmitting the media stream to the cloud as the recording stream using internet protocol television (IPTV). The media stream may be received from an input source selected from the group of input sources consisting of an antenna, a cable TV (CATV), and a recording. The recording may be selected from a group recording sources consisting of: a compact disc (CD), a digital versatile disc (DVD), a Blu-ray disc (BD), a digitized analog record, a digitized analog movie, and a computer readable medium.

The media stream may be selected from the group consisting of an audio stream, a video stream, and an audio-video stream. The means for storing may be stored as a computer program executable on a computer readable medium.

In the recording apparatus above the cloud may comprise: a networked cluster of one or more storage devices that operates as cloud storage; a cluster of one or more computers, which operate as cloud computers, networked to the cloud storage; and a cloud computer program executable on at least one of the cloud computers for performing one or more steps comprising: storing the recording stream to cloud storage.

In another aspect of the invention, a method of cloud storage and playback may comprise: providing an internet protocol television (IPTV) connection between a cloud and a playback device; searching, on the playback device, for a recording stored on the cloud; selecting, on the playback device, the recording stored on the cloud; and playing back, on the playback device, the recording stored on the cloud. The recording stored on the cloud may be selected from the group consisting of: an audio recording, a video recording, an audio-video recording, a time-shifted recording of one of the preceding, and a game program recording. Said playing back may comprise streaming the recording over the IPTV connection from the cloud to the playback device.

Said playing back may also comprise converting, on the cloud, the recording to an alternate format prior to, or simultaneously with, streaming the alternate format over the IPTV connection from the cloud to the playback device. The alternate format may correspond to a resolution and refresh rate displayable by the playback device.

The recording may be stored on the cloud by performing one or more steps comprising: providing a recording internet protocol television (IPTV) connection between the cloud and a recording device; searching, on the recording device, for programming to be stored on the cloud; selecting, on the recording device, the programming to be stored on the cloud; and streaming the programming over the recording IPTV connection from the recording device to the cloud, as a media stream; receiving, in the cloud, the media stream; and storing, in the cloud, the media stream into a stored medium in a collection of one or more stored media as the recording.

The recording device and the playback device may be either the same or different.

Said searching, on the playback device, for the recording stored on the cloud may comprise navigating a menu supplied by the cloud over the IPTV connection to the playback device.

In the method of cloud storage and playback above, the cloud may comprise: a networked cluster of one or more storage devices that operates as cloud storage; a cluster of one or more computers, which operate as cloud computers, networked to the cloud storage; and a cloud computer program executable on at least one of the cloud computers for performing one or more steps comprising: storing the recording to cloud storage; and playing back the recording. The cloud computer program may be stored as executable code on a computer readable medium.

In still another aspect of the invention, a playback apparatus may comprise: a playback device; and means for accessing a selected medium from a collection of one or more stored media stored on a cloud as a stored medium in a collection of one or more stored media. The means for accessing may comprise a playback computer program executable on the playback device for performing one or more steps comprising: establishing an internet protocol television connection between the playback device and the cloud; selecting one of the collection of one or more stored media on the cloud as the selected medium; and streaming the selected medium from the cloud to the playback device via the internet protocol television connection.

The playback device above may be selected from the group of devices consisting of a desktop computer, a laptop, a netbook, a tablet, a smart phone, a television (TV), and a set top box (STB).

Said selecting from above may comprise: interacting with a user to provide user input; accessing a listing of the collection of one or more stored media on the cloud; traversing the listing under user input; selecting the selected medium under user input; and instructing the cloud to transmit the selected medium to the playback device over the internet protocol television connection. The playback computer program executable may be stored as executable code on a computer readable medium.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a diagram of a cloud-based storage and playback system operating over internet protocol television (IPTV) linkages.

### DETAILED DESCRIPTION OF THE INVENTION

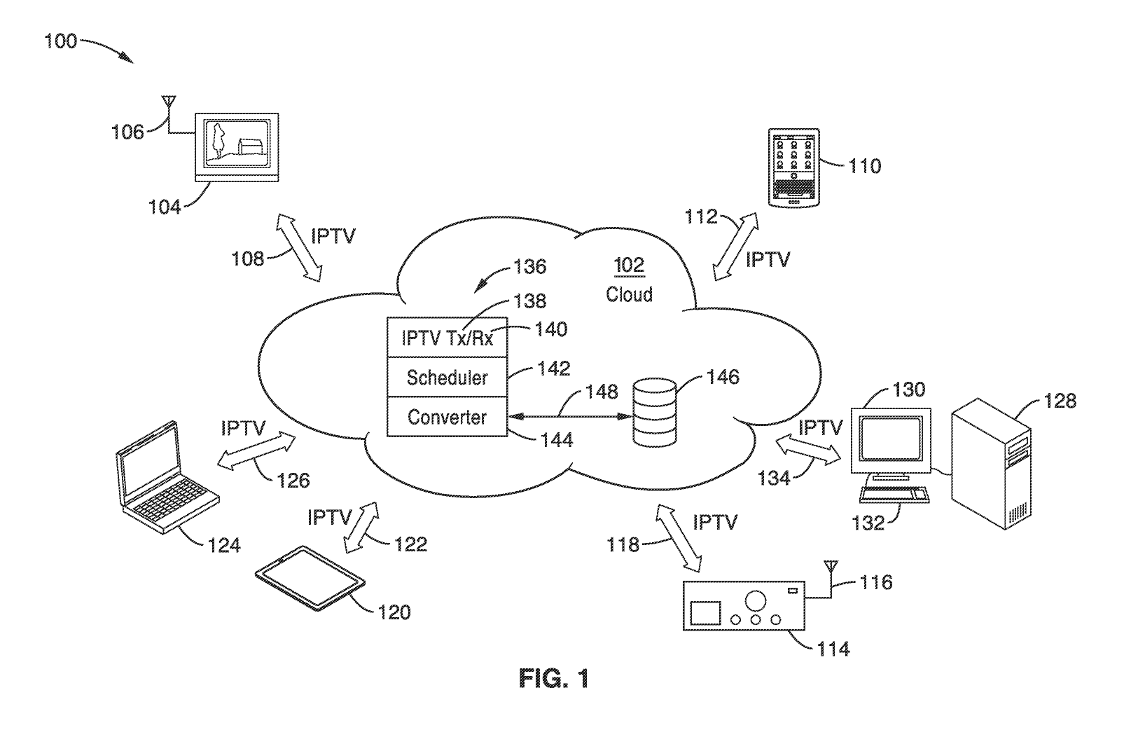

Refer now to FIG. 1, which is a diagram of a cloud-based storage and playback system 100. Here, a cloud based computing and storage network 102 is used for the storage of media. In one embodiment, a television set 104, is locally connected to an antenna 106. The television set 104 interconnects with the cloud 102 over an internet protocol television (IPTV) link 108. The IPTV link 108 between the cloud 102 and the local television set 104 allows the television set 102 to store programs locally received over the air from antenna 106 to the cloud 102. Thus, the program is stored on the cloud 102.

A smart phone 110, or other similar device may also connect to the cloud 102 through a separate IPTV connection 112 (which may be effected through a cellular, WiFi, or other data connection layer through which IPTV may be transmitted) so as to access recordings stored on the cloud 102.

Similarly, a dedicated receiver 114 may have its own local antenna 116 (or satellite antenna). By interconnecting with the cloud 102 via yet another IPTV link 118 commands may be passed from the cloud 102 to the dedicated receiver 114. Such commands may be used to direct the dedicated receiver 114 to tune to a certain frequency or format, and then proceed to store the output of the dedicated receiver 114 onto the cloud 102, again over the IPTV link 118.

A tablet device 120, such as an iPad™ may also connect to the cloud 102 via still another IPTV link 122. As the tablet device 120 is generally unable to directly receive television or radio emissions, but is generally able to connect to the cloud 102, the table device 120 is able to either stream live content passing into the cloud 102, or stored media already present on the cloud 102 over the IPTV link 122 present between the two.

Similarly, a laptop computer 124, or netbook, is able to access the cloud 102 through another IPTV connection 126. By using the laptop computer 124, content on the cloud 102 may be accessed over the IPTV connection 126. In turn, recordings present on the laptop computer 124, or recordings made by the laptop computer 124 may be stored directly onto the cloud 102.

In one final non-limiting example a desktop computer 128 may comprise a separate monitor 130, keyboard 132, etc. and communicate to the cloud 102 over an IPTV link 134 to either store content to the cloud 102, or to replay content already present on the cloud 102.

In still another example, the desktop computer 128 may send commands to the cloud 102 directing the cloud 102 to record a certain program (also referred to as a media stream). The cloud 102 may then direct a dedicated receivers 114 to select certain programming, and then proceed to transmit to the cloud 102 from the dedicated receiver 114 programming thus directed.

In this manner, devices with very limited storage may utilize the cloud 102 for media storage as a means for storing. The means for storing thus stores on the cloud a replayable version of the media stream so directed.

The cloud 102 has resident on it IPTV streaming software 136 that interacts with the various IPTV streams previously described. In a first level, IPTV packet streams are transmitted 138 and received 140. A scheduler 142 is used to keep track of when various programming is desired, both for recording and playback, and the device or devices used for such recording and playback (they may be distinct devices).

A converter 144 may be used to access stored media on a storage medium 146 over an intra-cloud link 148 to change the formatting or resolution of a program stored on the storage medium 146 for specific devices as required. In this manner, a high definition television, for example the television 104, may store on the cloud 102 a recording having excessive resolution and refresh rate when compared to the comparatively limited capabilities of the smart phone 110. Therefore, the smart phone 110 may request the cloud 102 to convert 144 a program stored on the storage medium 146 to a lower resolution, lower bandwidth stream that is within the capabilities of the smart phone 110.

Media streams may be stored to the cloud 102 via a means for storing, which may embody associating a received IPTV link (any of 108, 112, 118, 122, 126, or 134, among others, without limitation) to a storage medium 146 for storage. The storage medium 146 may be thought of as a collection of one or more stored media.

The means for storing may embody a recording computer program, executable by the recording device (the IPTV receiver Rx 140 in the cloud 102), for performing one or more steps comprising: accessing the media stream; and transmitting the media stream to the cloud 102 as the recording stream using internet protocol television (IPTV).

The means for accessing comprises a playback computer program executable on the playback device for performing one or more steps comprising: establishing an internet protocol television connection between the playback device and the cloud; selecting one of the collection of one or more stored media on the cloud as the selected medium; and streaming the selected medium from the cloud to the playback device via the internet protocol television connection. Said selecting may embody interacting with a user to provide user input; accessing a listing of the collection of one or more stored media on the cloud; traversing the listing under user input; selecting the selected medium under user input; and instructing the cloud 102 to transmit 138 the selected medium to the playback device over the internet protocol television connection.

Embodiments of the present invention are described with reference to flowchart illustrations of methods and systems according to embodiments of the invention. These methods and systems can also be implemented as computer program products. In this regard, each block or step of a flowchart, and combinations of blocks (and/or steps) in a flowchart, can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts support combinations of means for performing the specified functions, combinations of steps for performing the specified functions, and computer program instructions, such as embodied in computer-readable program code logic means, for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s).

From the discussion above it will be appreciated that the invention can be embodied in various ways, including the following:

1. A recording apparatus, comprising: a recording device; and means for storing a media stream received on the recording device to a cloud as a recording stream; wherein the recording stream is stored on the cloud as a stored medium in a collection of one or more stored media.

2. The recording apparatus of embodiment 1, wherein the means for storing comprises a recording computer program, executable by the recording device, for performing one or more steps comprising: accessing the media stream; and transmitting the media stream to the cloud as the recording stream using internet protocol television (IPTV).

3. The recording apparatus of embodiment 1, wherein the media stream is received from an input source selected from the group of input sources consisting of an antenna, a cable TV (CATV), and a recording.

4. The recording apparatus of embodiment 3, wherein the recording is selected from a group recording sources consisting of: a compact disc (CD), a digital versatile disc (DVD), a Blu-ray disc (BD), a digitized analog record, a digitized analog movie, and a computer readable medium.

5. The recording apparatus of embodiment 1, wherein the media stream is selected from the group consisting of an audio stream, a video stream, and an audio-video stream.

6. The recording apparatus of embodiment 1, wherein the means for storing is stored as a computer program executable on a computer readable medium.

7. The recording apparatus of embodiment 1, wherein the cloud comprises: a networked cluster of one or more storage devices that operates as cloud storage; a cluster of one or more computers, which operate as cloud computers, networked to the cloud storage; and a cloud computer program executable on at least one of the cloud computers for performing one or more steps comprising: storing the recording stream to cloud storage.

8. A method of cloud storage and playback, comprising: providing an internet protocol television (IPTV) connection between a cloud and a playback device; searching, on the playback device, for a recording stored on the cloud; selecting, on the playback device, the recording stored on the cloud; and playing back, on the playback device, the recording stored on the cloud.

9. The method of cloud storage and playback of embodiment 8, wherein the recording stored on the cloud is selected from the group consisting of: an audio recording, a video recording, an audio-video recording, a time-shifted recording of one of the preceding, and a game program recording.

10. The method of cloud storage and playback of embodiment 8, wherein said playing back comprises streaming the recording over the IPTV connection from the cloud to the playback device.

11. The method of cloud storage and playback of embodiment 8, wherein said playing back comprises:

converting, on the cloud, the recording to an alternate format prior to, or simultaneously with, streaming the alternate format over the IPTV connection from the cloud to the playback device.

12. The method of cloud storage and playback of embodiment 11, wherein the alternate format corresponds to a resolution and refresh rate displayable by the playback device.

13. The method of cloud storage and playback of embodiment 8, wherein the recording is stored on the cloud by performing one or more steps comprising: providing a recording internet protocol television (IPTV) connection between the cloud and a recording device; searching, on the recording device, for programming to be stored on the cloud; selecting, on the recording device, the programming to be stored on the cloud; and streaming the programming over the recording IPTV connection from the recording device to the cloud, as a media stream; receiving, in the cloud, the media stream; and storing, in the cloud, the media stream into a stored medium in a collection of one or more stored media as the recording.

14. The method of cloud storage and playback of embodiment 8, wherein the recording device and the playback device are either the same or different.

15. The method of cloud storage and playback of embodiment 8, wherein said searching, on the playback device, for the recording stored on the cloud comprises navigating a menu supplied by the cloud over the IPTV connection to the playback device.

16. The method of cloud storage and playback of embodiment 8, wherein the cloud comprises: a networked cluster of one or more storage devices that operates as cloud storage; a cluster of one or more computers, which operate as cloud computers, networked to the cloud storage; and a cloud computer program executable on at least one of the cloud computers for performing one or more steps comprising: storing the recording to cloud storage; and playing back the recording.

17. The method of cloud storage and playback of embodiment 16, wherein the cloud computer program is stored as executable code on a computer readable medium.

18. A playback apparatus, comprising: a playback device; and means for accessing a selected medium from a collection of one or more stored media stored on a cloud as a stored medium in a collection of one or more stored media.

19. The playback apparatus of embodiment 18, wherein the means for accessing comprises a playback computer program executable on the playback device for performing one or more steps comprising: establishing an internet protocol television connection between the playback device and the cloud; selecting one of the collection of one or more stored media on the cloud as the selected medium; and streaming the selected medium from the cloud to the playback device via the internet protocol television connection.

20. The playback apparatus of embodiment 18, wherein the playback device is selected from the group of devices consisting of a desktop computer, a laptop, a netbook, a tablet, a smart phone, a television (TV), and a set top box (STB).

21. The playback apparatus of embodiment 19, wherein said selecting comprises: interacting with a user to provide user input; accessing a listing of the collection of one or more stored media on the cloud; traversing the listing under user input; selecting the selected medium under user input; and instructing the cloud to transmit the selected medium to the playback device over the internet protocol television connection.

22. The playback apparatus of embodiment 21, wherein the playback computer program is stored as executable code on a computer readable medium.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A recording apparatus, comprising:
a recording device; and
means for storing a media stream received on the recording device to a cloud as a recording stream;
wherein the recording stream is stored on the cloud as a stored medium in a collection of one or more stored media.

2. The recording apparatus of claim 1, wherein the means for storing comprises a recording computer program, executable by the recording device, for performing one or more steps comprising:
accessing the media stream; and
transmitting the media stream to the cloud as the recording stream using internet protocol television (IPTV).

3. The recording apparatus of claim 1, wherein the media stream is received from an input source selected from the group of input sources consisting of an antenna, a cable TV (CATV), and a recording.

4. The recording apparatus of claim 3, wherein the recording is selected from a group recording sources consisting of: a compact disc (CD), a digital versatile disc (DVD), a Blu-ray disc (BD), a digitized analog record, a digitized analog movie, and a computer readable medium.

5. The recording apparatus of claim 1, wherein the media stream is selected from the group consisting of an audio stream, a video stream, and an audio-video stream.

6. The recording apparatus of claim 1, wherein the means for storing is stored as a computer program executable on a computer readable medium.

7. The recording apparatus of claim 1, wherein the cloud comprises:
a networked cluster of one or more storage devices that operates as cloud storage;
a cluster of one or more computers, which operate as cloud computers, networked to the cloud storage; and
a cloud computer program executable on at least one of the cloud computers for performing one or more steps comprising:
storing the recording stream to cloud storage.

8. A method of cloud storage and playback, comprising:
providing an internet protocol television (IPTV) connection between a cloud and a playback device;
searching, on the playback device, for a recording stored on the cloud;
selecting, on the playback device, the recording stored on the cloud; and
playing back, on the playback device, the recording stored on the cloud.

9. The method of cloud storage and playback of claim 8, wherein the recording stored on the cloud is selected from the group consisting of: an audio recording, a video recording, an audio-video recording, a time-shifted recording of one of the preceding, and a game program recording.

10. The method of cloud storage and playback of claim 8, wherein said playing back comprises streaming the recording over the IPTV connection from the cloud to the playback device.

11. The method of cloud storage and playback of claim 8, wherein said playing back comprises:
converting, on the cloud, the recording to an alternate format prior to, or simultaneously with, streaming the alternate format over the IPTV connection from the cloud to the playback device.

12. The method of cloud storage and playback of claim 11, wherein the alternate format corresponds to a resolution and refresh rate displayable by the playback device.

13. The method of cloud storage and playback of claim 8, wherein the recording is stored on the cloud by performing one or more steps comprising:
providing a recording internet protocol television (IPTV) connection between the cloud and a recording device;
searching, on the recording device, for programming to be stored on the cloud;
selecting, on the recording device, the programming to be stored on the cloud; and
streaming the programming over the recording IPTV connection from the recording device to the cloud, as a media stream;
receiving, in the cloud, the media stream; and
storing, in the cloud, the media stream into a stored medium in a collection of one or more stored media as the recording.

14. The method of cloud storage and playback of claim 8, wherein the recording device and the playback device are either the same or different.

15. The method of cloud storage and playback of claim 8, wherein said searching, on the playback device, for the recording stored on the cloud comprises navigating a menu supplied by the cloud over the IPTV connection to the playback device.

16. The method of cloud storage and playback of claim 8, wherein the cloud comprises:
a networked cluster of one or more storage devices that operates as cloud storage;
a cluster of one or more computers, which operate as cloud computers, networked to the cloud storage; and
a cloud computer program executable on at least one of the cloud computers for performing one or more steps comprising:
storing the recording to cloud storage; and
playing back the recording.

17. The method of cloud storage and playback of claim 16, wherein the cloud computer program is stored as executable code on a computer readable medium.

18. A playback apparatus, comprising:
a playback device; and
means for accessing a selected medium from a collection of one or more stored media stored on a cloud as a stored medium in a collection of one or more stored media.

19. The playback apparatus of claim 18, wherein the means for accessing comprises a playback computer program executable on the playback device for performing one or more steps comprising:
establishing an internet protocol television connection between the playback device and the cloud;
selecting one of the collection of one or more stored media on the cloud as the selected medium; and
streaming the selected medium from the cloud to the playback device via the internet protocol television connection.

20. The playback apparatus of claim 18, wherein the playback device is selected from the group of devices consisting of a desktop computer, a laptop, a netbook, a tablet, a smart phone, a television (TV), and a set top box (STB).

21. The playback apparatus of claim 19, wherein said selecting comprises:
interacting with a user to provide user input;
accessing a listing of the collection of one or more stored media on the cloud;
traversing the listing under user input;
selecting the selected medium under user input; and
instructing the cloud to transmit the selected medium to the playback device over the internet protocol television connection.

22. The playback apparatus of claim 21, wherein the playback computer program is stored as executable code on a computer readable medium.
